(19) United States
(12) Patent Application Publication
(10) Pub. No.: US 2002/0016188 A1
(43) Pub. Date: Feb. 7, 2002

(54) Wireless transceiver set

(76) Inventor: Iwao Kashiwamura, Tokyo (JP)

Correspondence Address: RABIN & CHAMPAGNE, PC, 1101 14TH STREET, NW, SUITE 500, WASHINGTON, DC, 20005, US

(21) Appl. No.: 09/886,619

(22) Filed: Jun. 22, 2001

(30) Foreign Application Priority Data
Jun. 22, 2000 (JP) 2000-187792
Feb. 26, 2001 (JP) 2001-050027

(51) Int. Cl. H04M 1/00

(52) U.S. Cl. 455/568; 455/569; 455/557

(57) ABSTRACT

This invention provides a wireless transceiver set for a cellular phone including a headset to be put on at a user's ear or head and an adapter unit which is to be connected to a cellular phone and which improves power saving during a stand-by mode in order to extend the life of battery therein longer. The headset includes a microphone, an earphone, a battery and a transceiver circuit to communicate through the adapter unit with a radio frequency. The adapter unit of the wireless transceiver set includes a battery, a transceiver circuit, detection means for periodically detect a radio frequency from the head set, and switch means for cutting off electric power supply from a battery to the circuit in the adapter unit when no radio frequency from the headset is detected. The invention also provides a wireless transceiver set for a stationary phone or a personal digital assistance including a headset to be put on at a user's ear so that a user can communicate over the standard phone or the PDA with hand-free condition.

### FIELD OF THE INVENTION

This invention generally relates to a wireless transceiver set, and, in particular, to a wireless transceiver set including a headset including a microphone, an earphone, a battery and a transceiver circuit therein and to be put on at a user's ear or head.

### BACKGROUND OF THE INVENTION

There is a prior art transceiver including a headset which is put on at a user's ear or head and in which a microphone and an earphone are incorporated. But, the prior art headset has a wire in order to connect with the transceiver so that electric signals from a microphone and to an earphone of the headset can be conveyed through the wire to and from the transceiver. Such a headset is called as hand-free set since a user can use his or her hands when taking over the transceiver by using such a headset. Such a headset is though to be convenient to use with a cellular phone during, for example, driving a car, since a user can put his or her hands on a steering wheel while talking over the cellular phone. However, the wire of such a headset is cumbersome and limits user's activity. Such a headset can only be used when a user is sitting or moving a limited range where the wire of such a headset can reach.

On the other hand, a cellular phone is widely used to have access to the Internet nowadays. Having access to the Internet with a cellular phone, a user watches contents displayed on a small monitor provided on a cellular phone and controls the access to the Internet by pushing buttons provided on a cellular phone with user's fingers. Accordingly, a microphone and a speaker provided on such a cellular phone are far from a user's mouse and ears. Consequently, a user must increase the volume of the speaker of the cellular phone and speak loudly to the microphone of the cellular phone. This would disturb people around a user.

In addition, a personal digital assistance (PDA) has capability to be used as cellular phone or to have access to the Internet. In this case, a microphone and a speaker are necessary for PDA.

There is a conventional wireless transceiver, such as, a child unit of a stationary phone to talk to a person connected over the stationary phone (a parent unit) through a radio frequency. Although such a child unit of a stationary phone is small, such a child unit is not so small as a headset to be put on at a user's ear or head.

If a wireless transceiver of headset type is used with a cellular phone, a stationary phone, or a PDA, the cumbersome wire would be eliminated and a user would be able to move freely with hand-free condition. In addition, a user would listen to sound or music from a cellular phone, a stationary phone, or a PDA and speak over a cellular phone, a stationary phone, or a PDA without disturbing others around a user with loud sound or speech. In addition, while watching contents displayed on the screen of small monitor of a cellular phone or a PDA as well as listening to sound through the Internet, a user can control access to the Internet by pushing small buttons or using pen on a cellular phone or a PDA. Moreover, with a wireless transceiver, there is no need to provide additional speaker and microphone on a PDA.

The wireless transceiver set comprises two units. One of which is a wireless headset to be put on at a user's ear or head, including all components of wireless transceiver including a microphone and an earphone for sending and receiving radio frequency signals. The other of which is an adapter unit directly connected to a cellular phone, PDA, or a stationary phone and including all components of transceiver for sending and receiving radio frequency signals to and from the wireless headset. Since a cellular phone or PDA is getting smaller and lighter, such a wireless transceiver set, including a headset and an adapter unit, to be used with a cellular phone or PDA should be much smaller and lighter than a cellular phone or PDA in order to be suitable for a cellular phone or PDA. Above all, the smaller and lighter a headset is, the more comfortably be a headset put on at a user's ear and head.

Therefore, a battery for a headset which is the largest and heaviest electric component in the headset should be small and light. Consequently, power saving for a battery of a headset is critical so that a wireless transceiver can be used for a reasonable period of time without replacing a battery. As for power source for an adapter unit, power source of a cellular phone, a stationary phone, or PDA might be used instead of a battery since an adapter unit is directly connected to a cellular phone, a stationary phone or a PDA. But, since each of cellular phone, stationary phone, or PDA has a different design to have its power source connect to an outside adapter unit, a battery is still a preferable power source for an adapter unit in order to avoid various design changes for an adapter unit to be connected to the power source of a cellular phone, a stationary phone, or a PDA. An adapter unit might be able to use a larger and heavier battery than a headset since an adapter unit is not put on at a user's ear or head but directly connected to a cellular phone, a stationary phone, or a PDA. A smaller and lighter power cell is, however, also preferable for an adapter unit since it would make an adapter unit smaller and lighter and less costly.

For example, a battery of small button type of which power capacity is very small (for example, the power capacity of 3 volt and 210 milliamperehour) is preferably used for power source of both headset and adapter unit in order to make a headset and an adapter unit appropriate size and weight with appropriate cost.

Accordingly, power saving for such a wireless transceiver set including a headset and an adapter unit during a stand-by mode and a communication mode is very critical so that a wireless transceiver set can be used for a reasonable period of time without replacing their small and light battery.

Particularly, power saving during a stand-by mode of a wireless transceiver set is more important since a stand-by mode is much longer than a communication mode of such a wireless transceiver set.

### SUMMARY OF THE INVENTION

One of the objects of the present invention is to improve power saving during a stand-by mode in a wireless transceiver set including a headset and an adapter unit in order to keep the wireless transceiver set alive for a reasonable period of time without replacing of a battery of small capacity in a headset and an adapter unit.

According to the present invention, there is provided a wireless transceiver set including an adapter unit adapted to be connected to a cellular phone and a headset adapted to be put on at a user's head portion, comprising: the adapter unit including a first CPU, a first battery, a first transceiver means for sending and receiving sound and control signals from and to the adapter unit through a radio frequency, a detection means for periodically detecting a radio frequency from the headset, and a first power switching means for supplying the adapter unit with electric power from the first battery when the detection means detects the radio frequency from the headset and for cutting off the electric power from the first battery when the detection means does not detect any radio frequency from the had set, and the headset including a second CPU, a second battery, a second transceiver means for sending and receiving sound and control signals from and to the headset through a radio frequency, and a second power switching means for supplying the headset with electric power from the second battery and for cutting off the electric power from the second battery in order to start and end communication through the adapter unit.

The first and second batteries may be a lithium battery of button type having the power capacity of 3 volts and 210 milliampere-hour. Alternatively, the first and second batteries may be a rechargeable battery. The detection means may periodically, for example, once every a few seconds, detect a radio frequency from the headset for a certain period of time, for example, 100 milliseconds. The first and second CPU may have means for translating protocols between the control information of the wireless transceiver set and the control information of the cellular phone.

In operation, during a sand-by mode, the adapter unit periodically check whether or not a radio frequency is received from the headset by detection means. If a radio frequency received from the headset is detected, the adapter unit continues to supply the adapter unit with electric power from the first battery by the first power switching means for communication between the headset and the cellular phone. If a radio frequency received from the headset is not detected, the adapter unit cuts off the electric power from the first battery to the transceiver means thereof by the first power switching means. Therefore, the adapter unit can save power consumption during a stand-by mode of the adapter unit in order to keep the first battery of the adapter unit alive for a longer period time. By choosing appropriate period of time for checking a radio frequency from a head set, the adapter unit would be able to respond to the radio frequency from a headset to establish the communication between the headset and the cellular phone through the adapter unit without significant delay. On the other hand, the headset controls the power saving by the second power switching means which switches manually on and off electric power from the second battery in the headset to the transceiver means thereof when communication over the cellular phone through the adapter unit starts and ends. Therefore, the headset can save power during unused mode of the headset in order to keep the second battery of the headset alive for a longer period time.

In another aspect of the present invention, there is provided a child unit of a stationary phone adapted to communicate over the stationary phone through a radio frequency, comprising: a headset adapted to be put on at a user's ear and including a microphone, an earphone, a battery therein, a transceiver means for sending and receiving sound signals to and from the stationary phone through a radio frequency, and a switch means for switching on and off electric power supply to the transceiver means from the battery in order to start or end communication over the stationary phone.

With the child unit of the invention, a user can talk over a stationary phone while walking freely around the stationary phone with hand-free condition.

In another aspect of the present invention, there is provided a wireless transceiver set for a personal digital assistance (PDA) to communicate over the personal digital assistance through a radio frequency, comprising: a headset adapted to be put on at a user's ear and including a microphone, an earphone, a battery therein, a transceiver means for sending and receiving sound signal through a radio frequency, and a switch means for switching on and off electric power supply to the transceiver means from the battery in order to start or end communication over the personal digital assistance.

With the wireless transceiver set of the invention, a user can talk over a personal digital assistance or listen to music over a personal digital assistance while watching contents displayed on a small display screen of the personal digital assistance through the Internet with hand-free condition.

These and other advantages will be apparent to those of ordinary skill in the art having reference to the specification in conjunction with the drawings.

### BRIEF DESCRIPTION OF THE DRAWINGS

In the drawings:

FIG. 1 shows a schematic diagram of a wireless transceiver set of a preferred embodiment in accordance with the invention;

FIG. 2 shows a schematic diagram of a wireless transceiver set shown in FIG. 1 in use condition;

FIG. 3 shows a block diagram of a circuit of an adapter unit to be connected to a cellular phone of a wireless transceiver set of a preferred embodiment in accordance with invention;

FIG. 4 shows a block diagram of a circuit of a headset to be put on at a user's head of a wireless transceiver set of a preferred embodiment in accordance with invention;

FIG. 5A shows a schematic diagram of a wireless transceiver set of another embodiment of the invention in use condition;

FIG. 5B shows a schematic diagram of a wireless transceiver set of still another embodiment of the invention in use condition;

FIG. 6 shows a block diagram of a circuit of a headset of a wireless transceiver set shown in FIGS. 5A and 5B to be put on at a user's head; and

FIG. 7 shows a block diagram of a circuit for use in a stationary phone shown in FIG. 5A.

In the drawings, the same or similar numerals are used to indicate the same, similar or corresponding parts or elements.

### DETAILED DESCRIPTION OF THE EMBODIMENTS

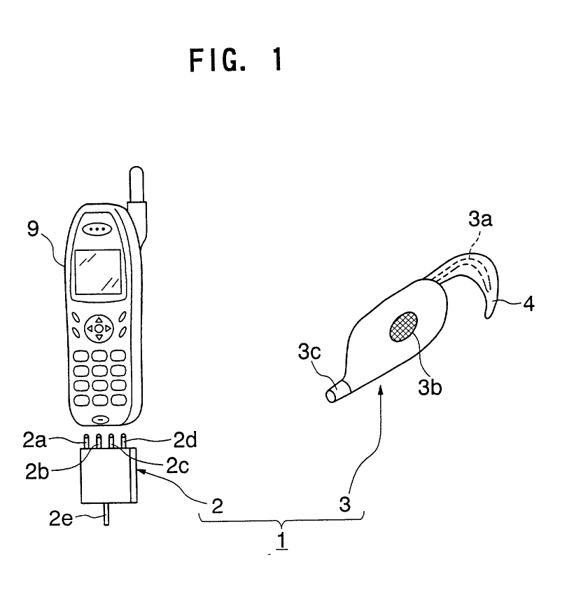

FIG. 1 shows a wireless transceiver set 1 of the first embodiment of the invention for a cellular phone. The wireless transceiver set 1 for a cellular phone includes an adapter unit 2 adapted to be connected to external connector (not shown) provided at the bottom of a cellular phone 9 of off-the-shelf type and a headset 3 adapted to be put on at a user's ear. The adapter unit 2 has a microphone plug 2a, an earphone plug 2b, a control data input plug 2c, and a control data output plug 2d which are provided at one end of the adapter unit and are adapted to be inserted into the external connector (not shown) provided at the bottom of the cellular phone 9. The adapter unit 2 also has an antenna 2e at the other end.

The headset 3 has an attachment member 4 at one end which is to be put on at a user's ear and has a shape like a hook of glasses. This attachment 4 may have an antenna 3a embedded in. The headset 3 also has an earphone 3b at a center portion of the headset 3 facing an ear of a user. The headset 3 has a microphone 3c at the other end opposite to the attachment 4.

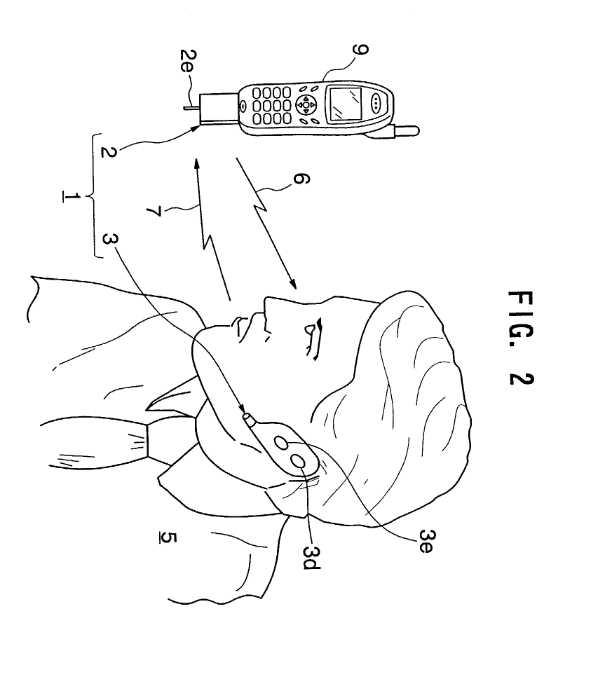

FIG. 2 shows the wireless transceiver set 1 in use condition in which the adapter unit 2 is connected to the external connector (not shown) at the bottom of a cellular phone 9 and the headset 3 is put on at a user's 5 ear (not shown). The headset 3 has a communication start and end switch button 3e and redial switch button 3d provided on the other surface opposite to the earphone 3b so that a user 5 can push the buttons 3e and 3d. The microphone 3c of the headset 3 is located near the mouth of a user 5 when the headset 3 is put on at a user's ear.

The adapter unit 2 of the wireless transceiver set 1 can send sound signals received from the cellular phone 9 to the headset 3 with a frequency modulated radio frequency 6 at 314 MHz. The headset 3 of the wireless transceiver set 1 can send sound signals from a user 5 to the adapter unit 2 with a frequency modulated radio frequency 7 at 223 MHz. In addition, the adapter unit 2 can send control data output signal from the cellular phone 9 to the headset 3 with the frequency modulated radio frequency 6. The headset 3 can send control data input signal from the headset 3 to the cellular phone 9 through the adapter unit 2 with the frequency modulated radio frequency 7.

The output power of transmission of radio frequency 6 from the adapter unit 2 is about 0.001 milliwatt. The output power of transmission of radio frequency 7 from the headset 3 is about 0.001 milliwatt. This transmission output power is large enough to establish communication between the adapter unit 2 and the headset 3 if the adapter unit 2 and the headset 3 are located within 3 meter distance.

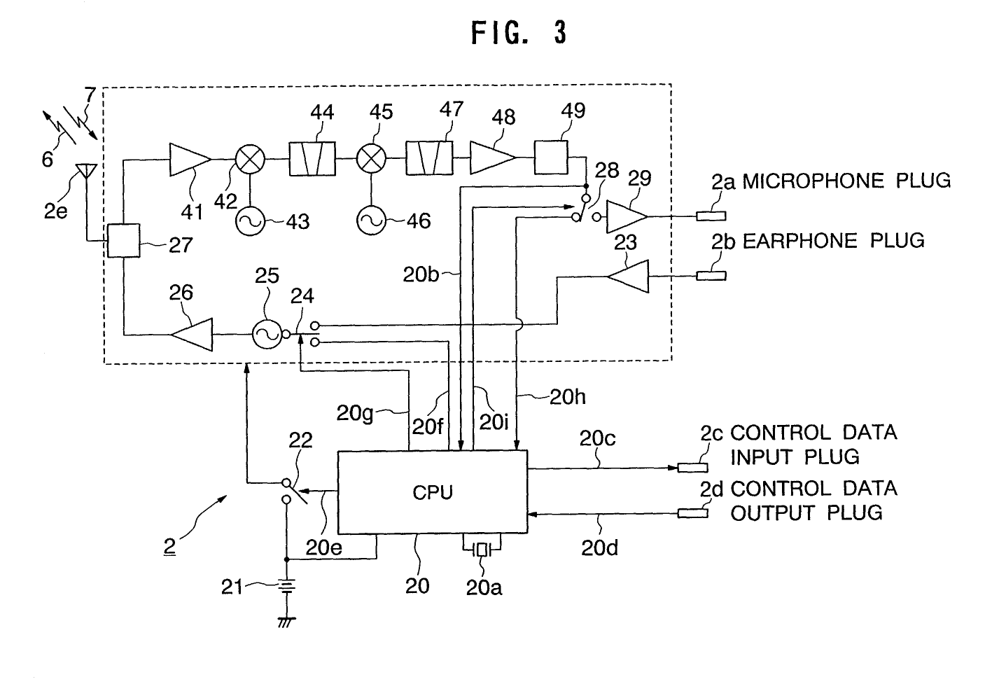

FIG. 3 shows a block diagram of a circuit of the adapter unit 2 according to a preferred embodiment of the invention. The adapter unit 2 includes a CPU 20 and a battery 21, for example, a lithium button battery of consumption type (Type No.CR2032A). The CPU 20 has a CPU clock 20a and is directly connected to the battery 21. The battery 21 also supplies electric power to all over the adapter unit 2 including a transceiver circuit of the adapter unit 2 through a switch 22. The battery 21 has the capacity of 3 volt and 210 milliampere-hour. Therefore, in order to assure a continuous 10 hour communication time with this battery 21, it is necessary for the adapter unit 2 to keep the overall current in a communication mode is less than 20 milliampere, that is, to keep overall power consumption in a communication mode is less than 60 milliwatt, and to supply the adapter unit 2 with the rest of electric power, 10 milliampere-hour, for overall stand-by mode of the adapter unit 2.

The CPU 20 is connected to a control data input plug 2c and a control data output plug 2d through lines 20c and 20d, respectively. When the control data input plug 2c and the control data output plug 2d are plugged into the external connector (not shown) provided at the bottom of the cellular phone 9, a switch means (not shown) in the CPU 20 becomes on-condition in order to reset the CPU 20, and then to start a CPU clock 20a, and then to set the adapter unit 2 in a stand-by mode. When the adapter unit 2 is removed from the bottom of the cellular phone 9, the control data input plug 2c and the control data output plug 2d of the adapter unit 2 are also detached from the cellular phone 9. Therefore, the switch means (not shown) in the CPU 20 becomes off-condition, the CPU 20 sets the adapter unit 2 in an unused condition from a stand-by mode. In the unused condition, all circuit but the CPU 20 of the adapter unit 2 is cut off from the battery 21 and is not supplied with electric current from the battery 21.

In a stand-by mode, a line 20b from the receiver circuit of the adapter unit 2 is connected to the CPU 20 in order to detect if there is a radio frequency 7 received from the headset 3. The CPU 20 is programmed to periodically, for example, once every 2 seconds, makes a switch 22 on-condition through a line 20e for a certain period, for example, 100 milliseconds, and supplies transceiver circuit including the receiver and transmission circuits of the adapter unit 2 with electric power from the battery 21 so as to check whether or not there is a radio frequency 7 received from the headset 3. If the CPU 20 detects a radio frequency 7 received from the headset 3 through the line 20b, the CPU 20 keeps the switch 22 on-condition and keeps the adapter unit 2 in a communication mode. The overall power consumption of the adapter unit 2 in a communication mode is held less than 60 milliwatt.

If the CPU 20 does not detect any radio frequency 7 from the headset 3 through the line 20b, then the CPU 20 cut off the switch 22 through the line 20e and stops the power supply from the battery 21 to the transceiver circuit including the receiver and transmission circuits of the adapter unit 2. And then, the CPU 20 continues the same procedure as explained before during a stand-by mode. During a stand-by mode as well as unused mode, the CPU 20 is always supplied with electric power from the battery 21, the power consumption by the CPU 20 is very small and less than or at most equal to the leakage current from the battery 21 since the CPU 20 is made by CMOS technology. Therefore, this power consumption by the CPU 20 is almost negligible in the unused mode. In a stand-by mode, the adapter unit 2 periodically supplies the transceiver circuit thereof with electric power from the battery 21 to check if there is a radio frequency 7 received from a headset 3, for example, once every 2 seconds for 100 milliseconds. By using such a periodical check, the power consumption in a stand-by mode of the adapter unit 2 per hour can be reduced to as low as one two hundredth (1/200) of power consumption for a communication mode of the adapter unit 2 per hour. As a result, the 10 milliampere-hour power capacity of the battery 21 can keep the adapter unit alive in a stand-by mode for about 100 hours.

The CPU 20 converts the protocols of control data from the cellular phone 9 via the plug 2d and the line 20d into the protocols for the wireless transceiver 1 and then the CPU 20 outputs the control data converted for the wireless transceiver 1 on a line 20f to send to the headset 3. The adapter unit 2 can send sound signal output from the cellular phone 9 through an earphone plug 2b and an amplifier 23 or the control data on the line 20f from the cellular phone 9 to the headset 3 by switching a switch 24 via a line 20g by the CPU 20. The transmission circut of the transceiver circuit of the adapter unit 2 includes a phase locked loop (PLL) 25, an amplifier 26, a separation circuit 27 in order to send sound and control data signals from the cellular phone 9 via an antenna 2e to the headset 2 with a frequency modulated radio frequency 6.

The CPU 20 converts the protocols (procedures) between the control data from outside connectors (not shown) at the bottom of the cellular phone 9 and the control data of the wireless transceiver set 1 of the invention. By using this protocol conversion, not only sound signal but also control data can be transferred between the cellular phone 9 and the wireless transceiver set 1. The control data transferred between the cellular phone 9 and the wireless transceiver set 1 includes, such as, control data for starting and ending communication over the cellular phone 9 and dial number data.

The CPU 20 converts the protocols of control data received from the headset 3 and output the converted protocol of the control data on the line 20c in order to send to the cellular phone 9 through the control data input plug 2c. The adapter unit 2 can input sound signal received from the headset 3 through a frequency modulated radio frequency 7 into the cellular phone 9 via an amplifier 29 and a microphone plug 2a and control data received from the headset 3 through a frequency modulated radio frequency 7 into the cellular phone 9 via the line 20h, the CPU 20 for protocol conversion, the line 20c and the plug 2c by switching a switch 28 via a line 20i by the CPU 20.

The receiver circuit of the transceiver circuit of the adapter unit 2 further includes amplifiers 41 and 48, mixers 42 and 45, PLLs 43 and 46, filters 44 and 47, and a demodulation circuit 49 for demodulating and amplifying a frequency modulated radio frequency 7 received from the separation circuit 27 and the antenna 2e.

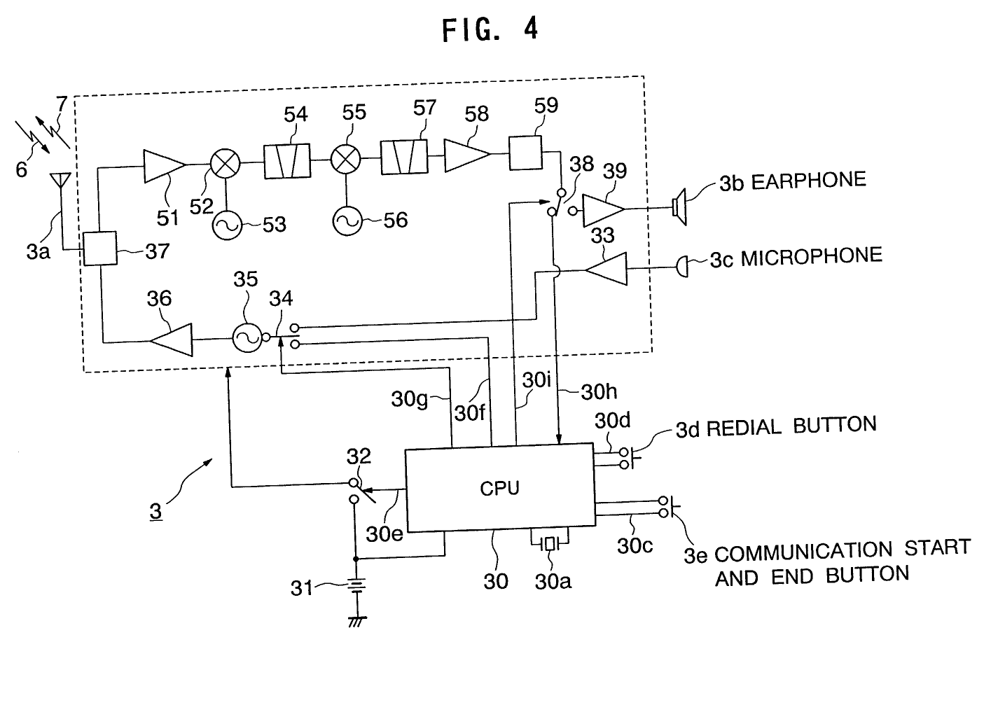

FIG. 4 shows a block diagram of circuit of the headset 3 according to an embodiment of the invention. The headset 3 includes a CPU 30 and a battery 31, for example, a lithium button battery of consumption type (Type No.CR2032A). The CPU 30 has a CPU clock 30a and is directly connected to a battery 31. The battery 31 also supplies electric power to all circuits in the headset 3 including a transceiver circuit of the headset 3 through a switch 32. The battery 31 has the capacity of 3 volt and 210 milliampere-hour. Therefore, in order to assure a continuous 10 hour communication time with this battery 31, it is necessary for the headset 3 to keep the overall power consumption in a communication mode is less than 60 milliwatt.

The CPU 30 is connected to a communication start and end switch 3e through a line 30c and a redial switch 3d through lines 30d, respectively. A user picks the headset 3 up and put on the headset 3 at a his/her ear when he/she hears a ring or telephone call from the cellular phone 9 informing the user of an incoming call. When a user pushes the communication start and end switch 3e, a switch means (not shown) in the CPU 30 becomes on-condition in order to reset the CPU 30, and then to start a CPU clock 30a, and then to make a switch 32 on-condition through a line 30e. Electric power from the battery 31 is supplied to the overall transceiver circuit of the headset 3 and the headset 3 is set in a communication mode in order to send a radio frequency 7 from the headset.

As explained in the above, the adapter unit 2 periodically checks if there is a radio frequency 7 from the headset 3, for example, once every 2 seconds for 100 milliseconds. If the adapter unit 2 receives a radio frequency 7 from the headset 3, the adapter unit 2 supplies electric power from the battery 21 to all circuits in the adapter unit 2 in order to change the adapter unit 2 from a stand-by mode to a communication mode.

When the adapter unit 2 is changed from a stand-by mode to a communication mode and receives control data indicating the start of communication from the headset 3 generated by pushing the communication start and end button 3e of the headset 3, the CPU 20 of the adapter unit 2 converts the protocol of the control data indicating the start of communication as explained in the above to the protocols for the cellular phone 9 in order to make the cellular phone 9 in a communication mode, that is, a hook-up condition.

In a communication mode, the headset 3 sends sound signals of the user's speech from a microphone 3c to the adapter unit 2 via an amplifier 33, a switch 34, a PLL 35, an amplifier 36, a separation circuit 37 and an antenna 3a with a frequency modulated radio frequency 7.

When communication is over, the user 5 pushes the communication start and end button 3e again. Then, control data indicating communication end is sent from the headset 3 to the adapter unit 2 and the CPU 30 makes the switch 32 off-condition through the line 30e. The headset 3 cuts off the electric power supply to the transceiver circuit of the headset 3 in order to stop sending a radio frequency 7 to the adapter unit 2. Receiving the control data from the headset 3 generated by pushing the communication start and end button 3e again, the adapter unit 2 converts the protocols of the control data as explained in the above to the protocol of the cellular phone 9 in order to instruct the cellular phone 9 to end the communication mode, that is, to make the cellular phone hang-up condition.

Then, the adapter unit 2 returns to a stand-by mode to periodically check if there is a radio frequency 7 from the headset 3 again as explained before. If there is no radio frequency 7 from the headset 3, the adapter unit 2 makes the switch 22 off-condition to stop electric power supply to the transceiver circuit of the adapter unit 2.

The headset 3 keeps the power consumption in a communication mode less than 60 milliwatt and virtually zero in a nonuse condition so that the headset 3 can make a 10 hour continuous communication time available with the battery 31 of the above-explained capacity.

If a user 5 pushes the redial switch 3d, the CPU 30 of the headset 3 outputs control data on a line 30f to instruct the cellular phone 9 to dial with a dial number of the latest call which is stored in a memory of the cellular phone 9. The CPU 30 controls a switch 34 through a line 30g to connect to the line 30f in order to send the control data on the line 30f to the cellular phone 9 with a frequency modulated radio frequency 7. The adapter unit 2 receives the control data sent from the headset 3 through a frequency modulated frequency 7 and then the CPU 20 converts the protocols of the received control data to the protocols of the cellular phone 9 in order to send the control data to the cellular phone 9 through the control data input plug 2c. The control data converted into the protocols of the cellular phone 9 instructs the cellular phone 9 to redial with the dial number of the latest call stored in a memory of the cellular phone 9. If the cellular phone 9 is connected to the redialed number, the headset 3 is in a communication mode over the cellular phone with the adapter unit 2. When the communication is over, the communication start and end button 3e is pushed to make the cellular phone 9 hang-up condition. Additionally, the redial switch 3d of the headset 3 may be able to make a call with dial numbers other than the latest call.

The CPU 30 can receive control data through 30h from the cellular phone 9 which is converted by the adapter unit 2 for the protocols of the wireless transceiver set 1. The headset 3 outputs sound signals from the cellular phone 9 with a radio frequency 6 to a user's ear through an earphone 3b and an amplifier 39 or control data from the cellular phone 9 with a radio frequency 6 to the CPU 30 through the line 30h. The control data from the cellular phone 9 includes, such as, control data indicating a ring of incoming call and communication start and end. The control data received by the CPU 30 can be used to control the circuit of the head set 3. For example, the control data indicating a ring of incoming call may automatically set the CPU 30 of the headset 3 in a communication mode. The receiver circuit of the transceiver circuit of the headset 3 includes amplifiers 51 and 58, mixers 52 and 55, PLLs 53 and 56, filters 54 and 57, and a demodulation circuit 59 for demodulating and amplifying a frequency modulated radio frequency 6 received from the antenna 3a and the separation circuit 37.

In operation, an wireless transceiver set 1 for a cellular phone 9 according to the invention have its adapter unit 2 attached to the external connector of a cellular phone 9 and have its headset 3 in a pocket of clothes which a user is wearing. When the user hears a ring indicating an incoming call from the cellular phone 9, he/she puts on the headset 3 at his/her ear and pushes a communication start and end button 3e to start communication over the cellular phone 9. In order to end the communication, the user pushes the communication start and end button 3e again.

If a user wants to talk over the cellular phone 9 to the latest caller, he/she can push the redial button 3d to make a call.

Even if a cellular phone 9 is stored in a briefcase or put on a seat aside in a car, a user can make a call over the cellular phone without holding the cellular phone in hand. Therefore, the wireless transceiver set 1 of the invention is very convenient.

According to the wireless transceiver set 1 of the present invention, the adapter unit 2 attached to a cellular phone periodically, for example, every 2 seconds, supplies the transceiver circuit of the adapter unit 2 with electric power from the battery 21 for a predetermined period, for example, 100 milliseconds, in order to check if there is a radio frequency 7 from the headset 3. If the adapter unit 2 detects a radio frequency 7 from the head set 3, the adapter unit 2 continues to supply the transceiver circuit of the adapter unit 2 with electric power from the battery 21 to establish communication between the adapter unit and the headset. Otherwise, the adapter unit 2 cuts off electric power supply from the battery 21 to the transceiver circuit of the adapter unit 2 in order to save power consumption of the battery 21 and continues a stand-by mode. As a result, power consumption in a stand-by mode per hour can be reduced to as low as about one two hundredth (1/200) of power consumption in a communication mode per hour. Therefore, the wireless transceiver set 1 of the invention can extend the period of stand-by mode longer with such a small and light battery.

On the other hand, as for the headset 3, the communication start and end button 3d can connect and disconnect the battery 31 to and from the transceiver circuit of the headset 3. Therefore, only in a communication mode, the battery 31 supplies the transceiver circuit of the headset 3 with electric power for communication. There is no stand-by mode in the headset 3. There are only two modes, a communication mode and a nonuse mode in the headset 3. Although the CPU 30 is always connected to the battery 31 even in the nonuse mode, since power consumption of CPU 30 made by CMOS technology during the nonuse mode in the headset 3 is the same as or less than the leakage current of the battery 31, the headset 3 can assure a 10 hour continuous communication time with such a small battery.

The wireless transceiver set of the invention can prevent power consumption of small battery in a stand-by mode so as to assure longer standby time and communication time.

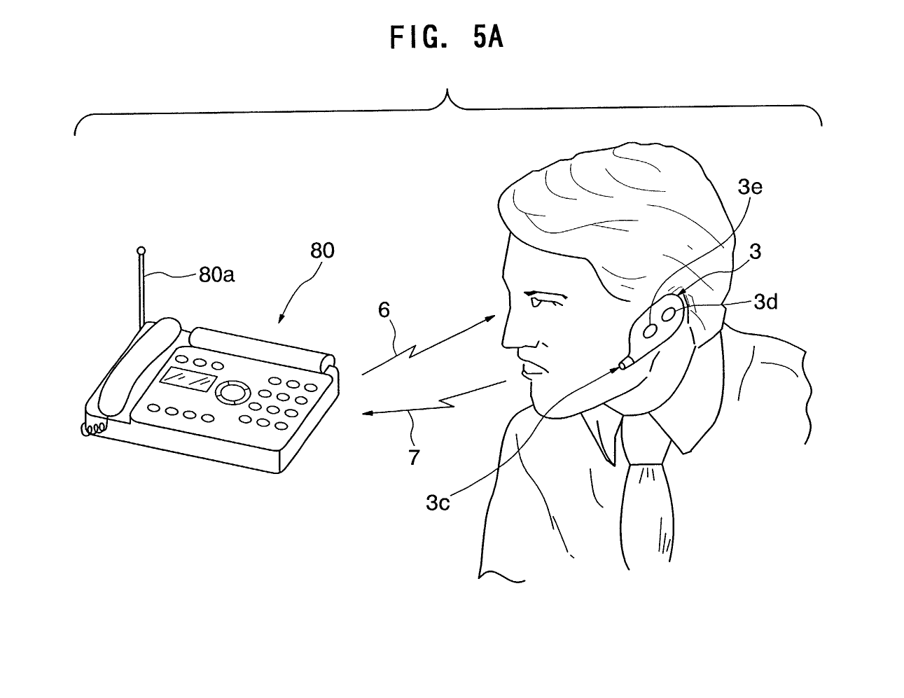

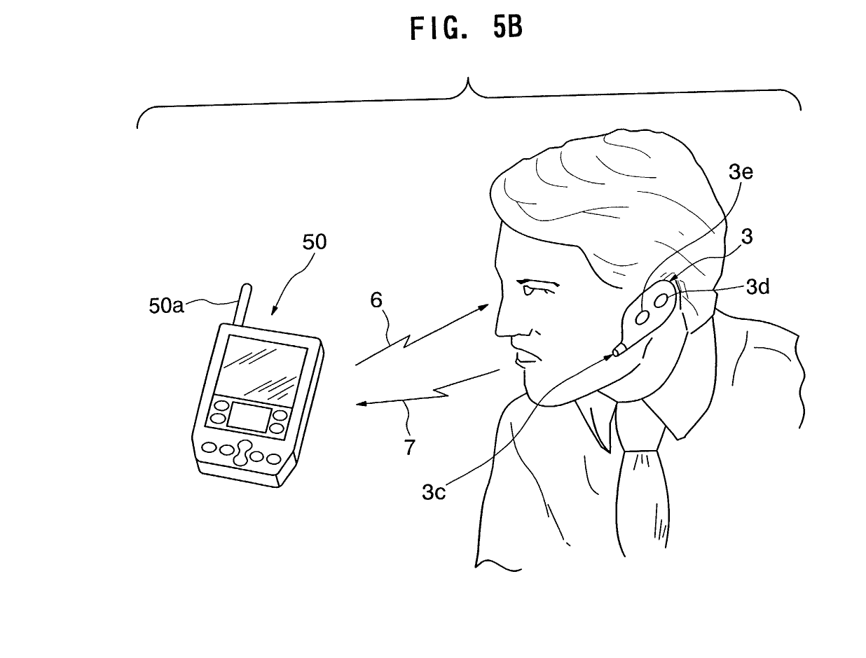

FIG. 5A shows another embodiment of the invention. In this embodiment, a headset 3 put on at a user's ear is used as a child unit of a standard or stationary phone 80. The headset 3 has an earphone (not shown) as shown in FIG. 1 and can be put on at a user's ear with a hook (not shown). The headset 3 also has a microphone 3c to make a set of earphone and microphone. The headset 3 may further includes a communication start and end button 3e and a redial switch 3d.

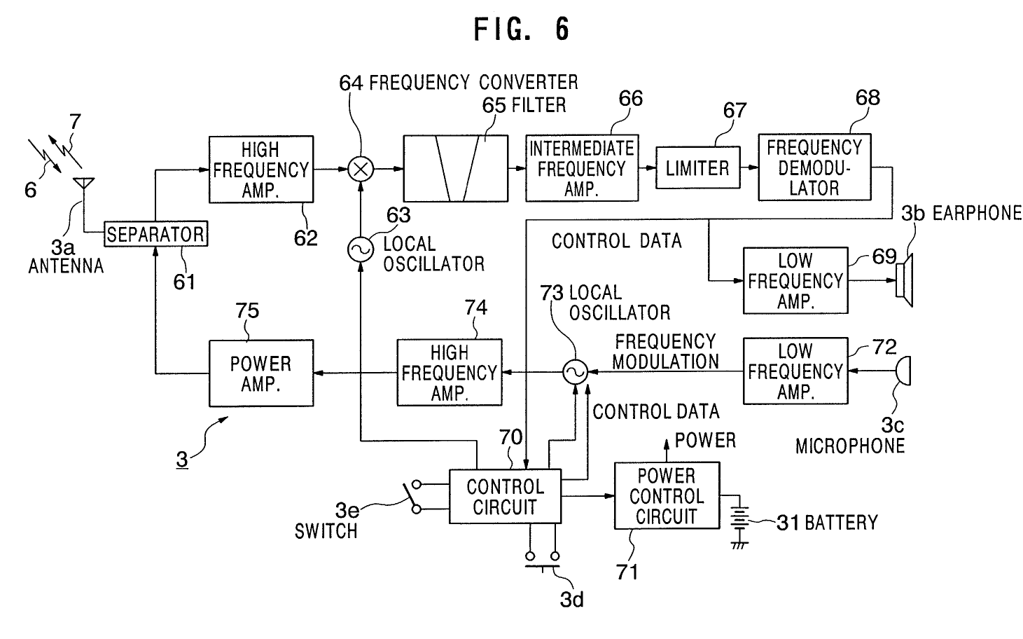

FIG. 6 shows a block diagram of the circuit included in the headset 3 to be used as a child unit of the stationary phone 80 of FIG. 5A. The receiver circuit of the headset 3 includes an antenna 3a incorporated in a hook for ear, a separation circuit 61 for connecting the receiver circuit and a transmission circuit to the antenna 3a, a high frequency amplifier 62 for amplifying a radio frequency 6 from the stationary phone 80 received by the antenna 3a, a frequency converter 64 connected to a local oscillator 63 of variable frequency PLL (phase locked loop) type for converting a received frequency, a filter 65, an intermediate frequency amplifier 66, a limiter 67, a frequency demodulator 68, a low frequency amplifier 69 for amplifying sound signal demodulated by the frequency modulator 68, an earphone 3b for outputting sound signal from the low frequency amplifier 69, and a control circuit 70 including a CPU to which control data demodulated by the frequency demodulator 68 is supplied.

The communication start and end switch 3e and the redial switch 3d are connected to the control circuit 70 which controls communication between the headset 3 and the stationary phone 80. For example, the control circuit 70 sends and receives data for determining the transmission and receiving frequencies to control the radio frequencies 6 and 7 through the local oscillators 63 and 73, informs a ring indicating an incoming call, and controls on and off conditions of the communication start and end button 3e and of the redial button 3d in the headset 3. A power supply control circuit 71 for controlling electric power supply from a battery 31 to all circuits in the headset 3 is connected to the control circuit 70 in order to save power consumption. For example, the control circuit 70 periodically controls power supply to the receiver circuit of the headset 3 to save power consumption of the battery 31. The transmitter circuit of the headset 3 includes a microphone 3c, a low frequency amplifier 72, a local oscillator 73 of variable frequency PLL (phase locked loop) type, a high frequency amplifier 74, and a power amplifier 75 for sending user's sound signal inputted from a microphone and control data from the control circuit 70 to the stationary phone 80 through a radio frequency 7 via a separator 61 and the antenna 3a.

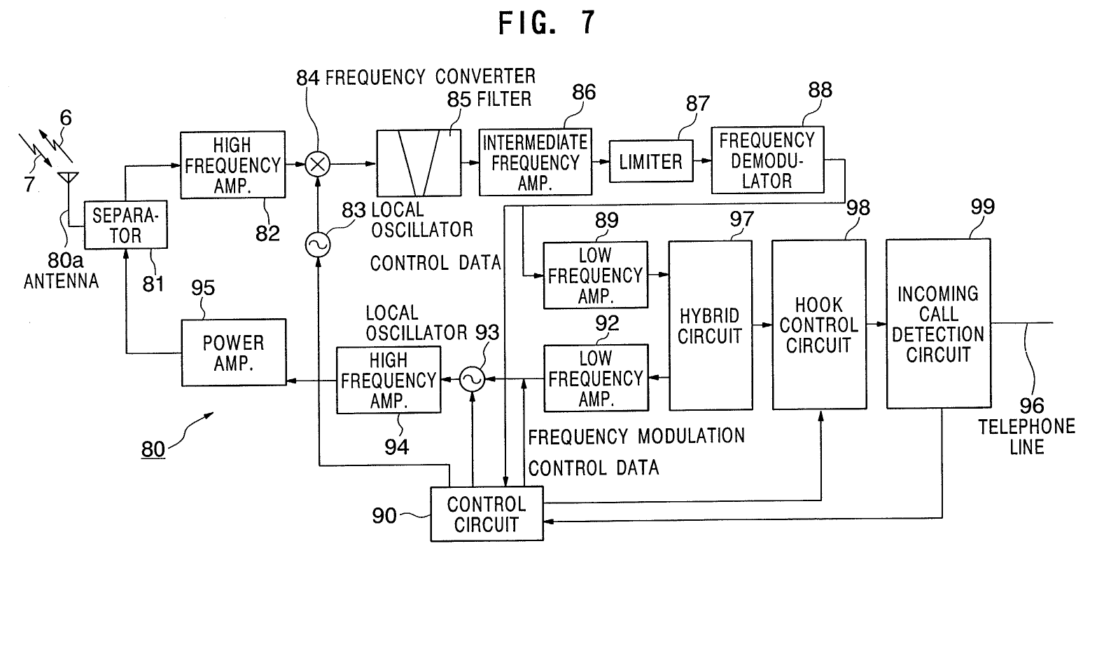

FIG. 7 shows a block diagram of circuit in the stationary phone 80 used as parent unit with the headset 3 of FIG. 5A through a radio frequency. The receiver circuit of the stationary phone 80 includes an antenna 80a, a separation circuit 81 for connecting both the receiver circuit and a transmitter circuit to the antenna 80a, a high frequency amplifier 82 for amplifying a radio frequency 7 from the headset 3 received by the antenna 80a, a frequency converter 84 connected to a local oscillator 83 of variable frequency PLL (phase locked loop) type for converting a received frequency, a filter 85, an intermediate frequency amplifier 86, a limiter 87, a frequency demodulator 88, a low frequency amplifier 89 for amplifying sound signals demodulated by the frequency modulator 88, a hybrid circuit 89 for sending and receiving sound signals from the low frequency amplifier 89 through a telephone line 96, a hook control circuit 98, an incoming call detection circuit 99 and a control circuit 90 including CPU to which control data demodulated by the frequency demodulator 88 is supplied.

The telephone line 96 may be in parallel with a telephone line connecting to the stationary phone 80. The circuit shown in FIG. 7 may not have dialing function for connection but only receiving function for receiving incoming calls. Dialing function in the stationary phone 80 may be used, instead. The control circuit 90 of FIG. 7 may have only redial function connecting to the dial number of the latest call only when the redial button 3d of the headset 3 of FIG. 6 is pushed. In addition, the control circuit 90 deals with an incoming call detection from the telephone line 96, hook control, various control data including control data generated by buttons 3e and 3d of the headset 3, frequency control of transmitting and receiving radio frequencies 6 and 7, and etc. The transmitter circuit of the stationary phone 80 includes an incoming call detection circuit 99 connected to the telephone line 96, a hook control circuit 98, a low frequency amplifier 72 connecting through a hybrid circuit 97, a local oscillator 93 of variable frequency PLL (phase locked loop) type, a high frequency amplifier 94, and a power amplifier 95 for sending sound signal inputted from the telephone line 96 and control data from the control circuit 90 through a radio frequency 6 via a separator 81 and the antenna 80a to the headset 3.

According to the embodiment shown in FIGS. 5A, 6 and 7, a user can talk over the headset 3 put on at a user's ear by pushing a button 3e through radio frequencies 6 and 7 sent to and received from the stationary phone 80 connected to the telephone line 96. A user can talk over the headset 3 with hand-free condition and walk around within the range where the radio frequencies 6 and 7 can reach. If a user pushes the redial button 3d of the headset 3, user can redial the number of the latest call through the stationary phone 80.

FIG. 5B shows another embodiment of the present invention. FIG. 5B shows a personal digital assistance (PDA) 50 in which a cellular phone, cordless digital phone or an internal modem is incorporated in order to connect to a telephone line. The PDA 50 includes the transceiver circuit as shown in FIG. 3 or the transceiver circuit as shown in FIG. 7 to send and receive radio frequencies 6 and 7 through an antenna 50a to and from a headset 3. The headset 3 includes the transceiver circuit as shown in FIG. 6. According to this embodiment, user can put on the headset 3 on his/her ear to talk over the headset 3 through the PDA 50 or to have access to the Internet through the PDA 50.

1. A wireless transceiver set including an adapter unit adapted to be connected to a cellular phone and a headset adapted to be put on at a user's head portion, comprising:
said adapter unit including a first CPU, a first battery, a first transceiver means for sending and receiving sound and control signals from and to the adapter unit through a radio frequency, a detection means for periodically detecting a radio frequency from the headset, and a first power switching means for supplying the adapter unit with electric power from the first battery when the detection means detects the radio frequency from the headset and for cutting off the electric power from the first battery when the detection means does not detect any radio frequency from the had set, and
said headset including a second CPU, a second battery, a second transceiver means for sending and receiving sound and control signals from and to the headset through a radio frequency, and a second power switching means for supplying the headset with electric power from the second battery and for cutting off the electric power from the second battery in order to start and end communication through the adapter unit.

2. The wireless transceiver set of claim 1, wherein said detection means detect a radio frequency from the headset every a few seconds.

3. The wireless transceiver set of claim 1, wherein said first and second batteries are batteries of button type.

4. The wireless transceiver set of claim 1, wherein said first and second batteries are rechargeable.

5. The wireless transceiver set of claim 1, wherein said first CPU converts protocols between control data of the cellular phone and the wireless transceiver set.

6. A child unit of a stationary phone adapted to communicate over the stationary phone through a radio frequency, comprising:
a headset adapted to be put on at a user's ear and including a microphone, an earphone, a battery therein, a transceiver means for sending and receiving sound signals to and from the stationary phone through a radio frequency, and a switch means for switching on and off electric power supply to the transceiver means from the battery in order to start or end communication over the stationary phone.

7. A wireless transceiver set for a personal digital assistance (PDA) to communicate over the personal digital assistance through a radio frequency, comprising:
a headset adapted to be put on at a user's ear and including a microphone, an earphone, a battery therein, a transceiver means for sending and receiving sound signal through a radio frequency, and a switch means for switching on and off electric power supply to the transceiver means from the battery in order to start or end communication over the personal digital assistance.
